(19) United States
(12) Patent Application Publication
(10) Pub. No.: US 2005/0243498 A1
(43) Pub. Date: Nov. 3, 2005

(54) Ionized oxygen curtain device

(76) Inventors: Bernard J. Mirowsky, Township of East Amwell, NJ (US); Paul D. Mirowsky, Lambertville, NJ (US)

Correspondence Address: Kenneth P. Glynn, Esq.;Glynn & Associates, P.C., 24 Mine Street, Flemington, NJ, 08822, US

(21) Appl. No.: 10/833,855

(22) Filed: Apr. 28, 2004

(51) Int. Cl. H01T 23/00

(52) U.S. Cl. 361/230

(57) ABSTRACT

An ionized oxygen curtain device for creating a gaseous curtain containing ionized oxygen may be used alone or in conjunction with one or more additional devices to isolate persons from otherwise harmful, noxious and potentially dangerous gases. The device includes: (a.) a main housing; (b.) an ionized oxygen generator in the main housing; (c.) a circulation mechanism; (d.) a gas intake upstream to provide oxygen-containing gas to the main housing; (e.) an ionized oxygen gas outtake downstream from the generator; and, (f.) a manifold member connected to the outtake, the manifold member being an elongated outlet in a predetermined geometry cross-sectional area so as to permit a curtain-like flow of ionized oxygen-containing gas therefrom. The ionized oxygen generator includes sufficient ionized oxygen generation to produce from about 2,000 to about 50,000 oxygen ions per cubic centimeter. Methods of use include protecting work areas and open basin areas.

### BACKGROUND OF THE INVENTION

1. Field of the Invention

The present invention relates to ionized oxygen curtain devices utilized to isolate operators, workers, neighbors, and people in general from exposure to VOCs and other airborne pollutants and odors. The gaseous curtain created by the device has defined direction, has specified range of oxygen ions per unit volume, and has significant velocity so that it both isolates an operator or other person from exposure to an otherwise irritating and/or harmful flow of undesirable gases, and reacts with those gases by providing sufficient ionized oxygen to react with and substantially reduce or eliminate them.

2. Information Disclosure Statement

The following prior art is representative of the state of the art in the field of air treatment systems:

U.S. Pat. No. 6,668,563 B2 describes an air treatment system for airplanes. It includes: (a.) an environmental conditioning system located within an airplane to provide at least one of heating, cooling, and compressing air, and has ingress ductwork to remove air from an airplane cabin into the system, and an air movement mechanism, e.g. blowers, or equivalent devices, to cycle the air from the cabin and into the environmental conditioning system via the ingress ductwork. It also has egress ductwork for return of treated air in to the cabin; and, (b.) an ionic oxygen generator connected to one or both of the ingress ductwork and the egress ductwork. The ionic oxygen generator may be one or more, and should be of sufficient capacity to generated at least 200 ions of ionic oxygen per cubic centimeter of incoming air for removal of airborne contaminants and odor from exiting air before it is returned to the cabin. Other embodiments are separate from the plane's environmental conditioning system and utilizes one or more ionic oxygen generators to treat airplane air separately.

U.S. Pat. No. 6,372,131 B1 describes a waste water treatment system which includes at least one closed, covered structure having waste water ingress and waste water egress and waste water treatment capabilities within the structure, and having an ambient air ingress with predetermined volumetric air flow rates, and having an ambient air egress for release of air to the atmosphere: and further includes an ionic oxygen generator connected to the air ingress or egress and has sufficient capacity to generate at least 200 ions of ionic oxygen for removal of odor from exiting air before it is released to the atmosphere. In some preferred embodiments, the waste water treatment is a dissolved air flotation treatment with at least one covered tank containing solid-liquid waste content, and includes sufficient pumping capacity to floatate solid component of the solid-liquid waste content of the tank.

Notwithstanding the prior art, the present invention is neither taught nor rendered obvious thereby.

### SUMMARY OF THE INVENTION

The present invention relates to an ionized oxygen curtain device for creating a gaseous curtain containing ionized oxygen. The device may be used alone or in conjunction with one or more additional devices to isolate persons from otherwise harmful, noxious and potentially dangerous gases. The device not only keeps harmful gases isolated, but also provides the oxygen ions to react and reduce or eliminate them. The device may be used in the workplace or other area to isolate and treat (deodorize) it, such as a specific portion of a room, an entire room, or a building, or to isolate and treat a fluid holding area, i.e., a basin. Thus, the curtains could be used to isolate windows and doors, other building or structure openings, chemical or other work areas or holding areas, e.g. a garbage transfer station or a plastic extruder.

The device includes: (a.) a main housing; (b.) an ionized oxygen generator located in the main housing; (c.) a circulation mechanism connected to the main housing; (d.) a gas intake upstream from the generator and connected to the main housing to permit oxygen-containing gas to enter the main housing; (e.) an ionized oxygen gas outtake downstream from the generator and connected to the main housing to permit ionized oxygen-containing gas to flow from the main housing; and, (f.) a manifold member connected to the outtake, the manifold member being elongated, and having an elongated outlet arrangement in a predetermined geometry cross-sectional area so as to permit a curtain-like flow of ionized oxygen-containing gas therefrom.

The present invention ionized oxygen curtain device ionized oxygen generator includes sufficient ionized oxygen generation to produce from about 2000 to about 50,000 oxygen ions per cubic centimeter. The circulation mechanism includes sufficient flow rate to establish a manifold member exit velocity of about ten to about sixty feet per second. In other words, this would be the preferred exit velocity of the ionized oxygen-containing curtain gas exiting at the manifold orifices

In some preferred embodiments, the manifold member is an elongated tubular member having a cross-section selected from the group consisting of circular, square, rectangular, oval and triangular. Other cross-sections would function within the scope of the present invention, but the aforesaid configurations are easier to fabricate. The circular and square cross-sections are most preferred for a number of reasons. First, they are both commercially available configurations. Second, the circular configuration is easily connected to tubing and hosing. Third, the square tubing configuration permits the outletting orifices or slit(s) to be in a single flat plane for straight-line curtain formation. This maximizes control; and inhibits dispersement or widening of the curtain away from the manifold. It is preferred that the internal (open) cross-sectional area of the elongated outlet arrangement of the manifold be limited so as to provide the exit velocities set forth above. This is one manner of assuring a strong exiting gas velocity to create a reliable curtain and to increase its effectiveness.

In some embodiments, the manifold member has a plurality of generally aligned orifices along a predetermined length. For example, one or two or three rows of round holes could be used, staggered, shifted, random or arranged in full vertical and/or horizontal alignment. The holes or orifices need not be round holes; they could be any shape, but fabrication by drilling yields round holes. Punched, molded or laser cut orifices or other fabrication techniques may provide for any shape hole that may be desired.

In other embodiments, the manifold has at least one elongated slit for the outlet arrangement. Instead of a single slit, for example, one that is an eighth of an inch wide and six feet long, a plurality of six-inch long slits in a single row could be used. Alternatively, more than one row could be utilized without exceeding the present invention scope. Combinations of holes and slit(s) could be used. In some embodiments, the orifice may circle or otherwise encompass all sides of the manifold in a single plane so as to create a radiating curtain or partially encircle to create a radiating arcuate curtain.

In the embodiments wherein the manifold member has a plurality of generally aligned orifices, they may be in a single, flat plane. Likewise, when there is at least one elongated slit or a combination of slit(s) and orifices, these may be located in a single plane. Alternatively, a plurality of generally aligned orifices, one or more slits or combinations thereof may be located on an arcuate plane no greater than 40 degrees, and preferably, no greater than 30 degrees. Thus, an arcuate or curved portion of an otherwise flat manifold, or an arc segment of an oval or round or other curved tubular member, would have a up to a forty degree, and preferably less than thirty degree, segment containing the orifices and/or slits.

In some embodiments, it may be useful, efficient or necessary to create more than one curtain, e.g., on opposite sides of exiting materials containing VOCs. Thus, the present invention also contemplates those embodiments wherein the outtake is connected to a plurality of sub-outtakes, and each of the sub-outtakes has its own manifold member to create its own curtain or curtain segment. For example three separate sub-outtakes could be connected to their own manifold members, and these could be positioned next to each other to create, for example, a fifteen-foot curtain. The manifold members a typically straight, but could be curved, elbowed or otherwise configured to fit a particular application.

The present invention is directed to the device described, as well as to the method of using the device. Hence, the present invention also includes a method of isolating a human work area from exposure to a volatile airborne contaminants source. This method includes:

I. providing an ionized oxygen curtain device of any of the configurations set forth above, and placing it between the human work area and the volatile airborne contaminants source; and

II. creating ionized oxygen curtain between unit the device between at least one human work area and the source of volatile airborne contaminants.

The present invention is also directed to isolating an open tank or and that emits undesirable odors or gasses. These sources of gaseous toxins and odors include chemical ponds, pig and other farm production waste holding ponds, human waste ponds and tanks and the like. This method includes:

I. providing an ionized oxygen curtain device of any of the configurations set forth above or elsewhere herein, and placing it between the atmosphere to be protected and the source of the volatile airborne contaminants; and

II. creating an ionized oxygen curtain between the atmosphere to be protected and the source of volatile airborne contaminants.

In all of these various embodiments of the present invention, the ionized oxygen reacts at least in part, with the contaminants to oxidize the pollutants and reduce or eliminate the odors and harmful effects of the undesirable gases.

### BRIEF DESCRIPTION OF THE DRAWINGS

The present invention should be more fully understood when the specification herein is taken in conjunction with the drawings appended hereto wherein:

FIG. 1 illustrates a top diagrammatic view of present invention ionized oxygen curtain device;

FIG. 2 shows a top view of a first manifold member configuration, and FIG. 3 shows a cut end view thereof;

FIG. 4 shows a top view of a second manifold member configuration, and FIG. 5 shows a cut end view thereof;

FIG. 6 shows a top view of a first manifold member configuration, and FIG. 7 shows a cut end view thereof;

FIGS. 8 and 9 show end views of other cross-sections of two alternative manifold members;

FIG. 10 shows a top view of a custom shaper manifold member of a present invention device;

FIG. 11 illustrates an end view of a present invention configuration in an extrusion plant, and FIG. 12 shows a cut top view thereof with the top hood removed;

FIGS. 12, 14, 15 and 16 show different examples of manifold arrangements; and,

FIG. 17 shows a top view of a basin using the present invention devices, and illustrates a method of the present invention.

### DETAILED DESCRIPTION OF THE PRESENT INVENTION

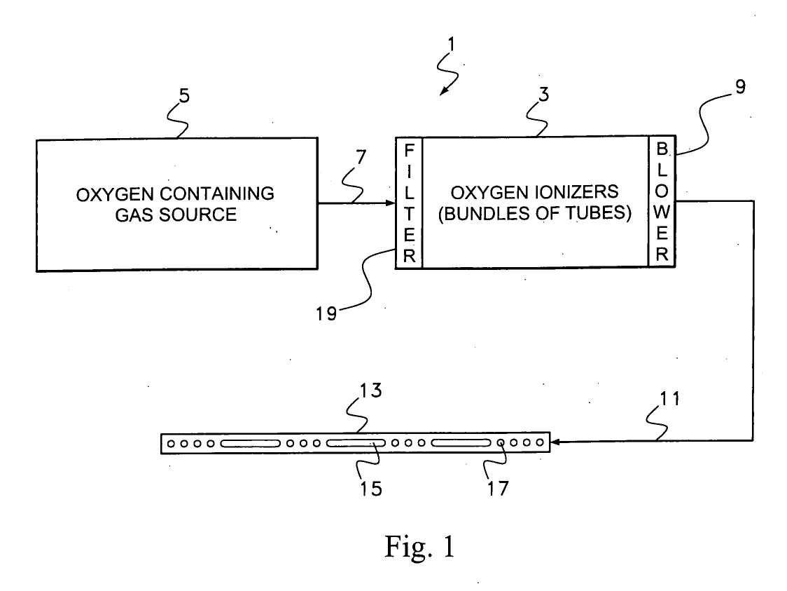

FIG. 1 illustrates a top diagrammatic view of present invention ionized oxygen curtain device 1. Device 1 includes a main housing 3 that houses an ionized oxygen generator, that is, a bundle of oxygen ionizers. These are a collection of oxygen ionizing tubes arranged at right angles to the flow of air or other oxygen-containing gas. The number of tubes and their power level are dependent on the specific application, but sufficient ionizers should be included to create at least 2,000 ionized oxygen molecules per cubic centimeter of gas exiting the main housing 3. The exact design of the ionizers is within the purview of the artisan and detail is presented in the prior art cited above.

A source of oxygen-containing gas 5 is fed to main housing 3 via a pipe, tube or other conduit, namely, gas intake 7, through one or more filters 19, if needed (if the source has particulates or other filterable undesirable contents). If the gas source is atmospheric air, then filtering may or may not be needed, although it is preferred. If the source is industrial oxygen, filtering may not be necessary. The oxygen-containing gas source is pulled in via blower 9, and other blowers could be used if the source is distant or there is a large volume. The gas passing through the main housing has its oxygen at least partially ionized, and the ionized oxygen (which is not harmful ozone) will subsequently react with the undesirable effluents.

Blower 9 moves the ionized oxygen gas from the main housing 3 through the outtake 11 to the manifold member 13. This manifold member is strategically positioned between a polluted or harmful gas source and a work area or other area where people may otherwise be exposed to that polluted or harmful gas. The manifold member 13 has a plurality of orifices, such as orifice 17, and of slits, such as slit 15, which are all in general alignment. Those shown in the Figure are the only openings in the manifold member 13, and create a wall of ionized gas to form the curtain that will both isolate the bad gases and treat the bad gases to reduce their harmful content. An important feature in the present invention is that the ionized oxygen gases exit the manifold member openings at some other angle than parallel with the general direction (central axis) of the elongation. Typically, the ionized oxygen exits at ninety degrees from the central axis of the elongated manifold members.

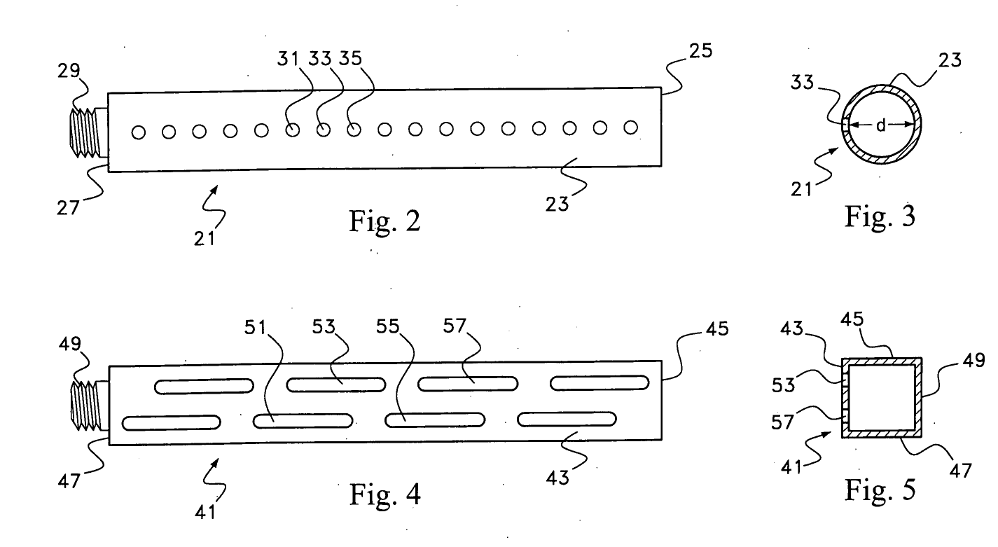

FIG. 2 shows a top view of a first manifold member configuration, and FIG. 3 shows a cut end view thereof. These are taken together, and like components are like numbered. Manifold member 21 is an elongated pipe 23 with a plurality of in-line orifices, such as orifices 31, 33, and 35. On the left end 27 is an outtake line connection 29 for connection to and outtake such as outtake 11 of FIG. 1 or other similar outtake from an ionized oxygen source. It has a closed opposite end 25. When replacing manifold member 13 of FIG. 1, it may be operated to create a tight, thin, strong, straight-line curtain of ionized oxygen-containing outflow. This manifold member could be used in an indoor or outdoor worksite to isolate workers from, or the atmosphere around, odorous or harmful gases, alone or in combination with additional manifold members, operating off the same or separate devices.

In FIG. 3, the inside diameter d is shown. In preferred embodiments, the cross-sectional area calculated with “d”, may be used to determine good ranges of gas flow to achieve strong curtains of ionized oxygen. Thus, the blower(s) or other circulation mechanism should be fast and powerful enough to provide a total gaseous flow rate to assure exit velocities of at least about ten feet per second.

FIG. 4 shows a top view of a second manifold member configuration, and FIG. 5 shows a cut end view thereof. Here, manifold member 41 is of square cross-sectional configuration, and has essentially a square tube shape with a top 43, sides 45 and 47, and a bottom 49. Instead of a single row of openings as above, to has two rows. The orifices have been replaced by slits, such as slits 51, 53, 55, and 57. It has a closed end 45 and an opposite end 47 with a threaded connection 49 for attachment to an ionized oxygen source.

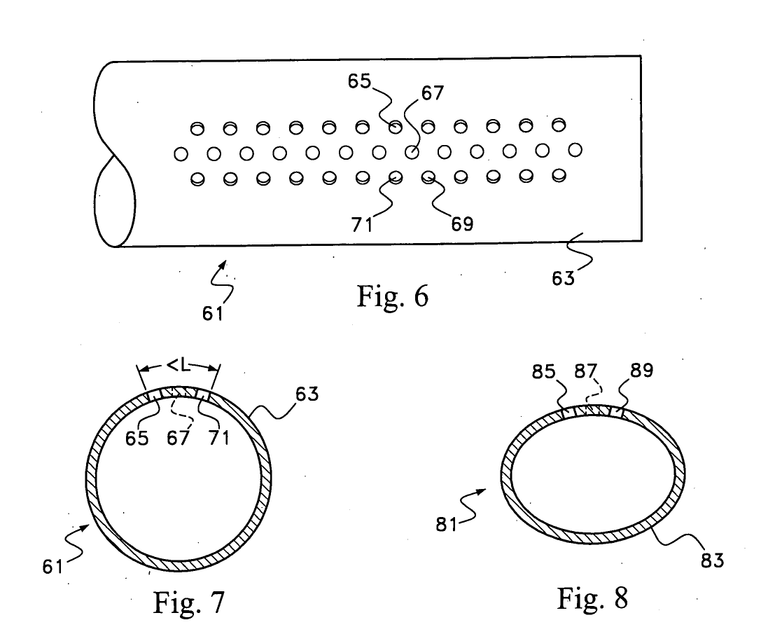

FIG. 6 shows a top view of a manifold member 61 and FIG. 7 shows a cut end view thereof. These Figures, as well as FIGS. 8, 9, and 10 are to illustrate different manifold configurations.

Manifold member 61 is a round tube with a plurality of orifices in three staggered rows, such as orifices 65, 67, 69 and 71. These could be randomly staggered or randomly arranged, but need to be kept within a specified arc if not in a single plane, as in FIGS. 4 and 5 above. Thus, angle “L” should be no greater than 40 degrees, and preferably, no greater than 30 degrees. Therefore, an arcuate or curved portion of an otherwise flat manifold, or an arc segment of an oval or round or other curved tubular member, would have a up to a forty degree, and preferably less than thirty degree, segment containing the orifices and/or slits.

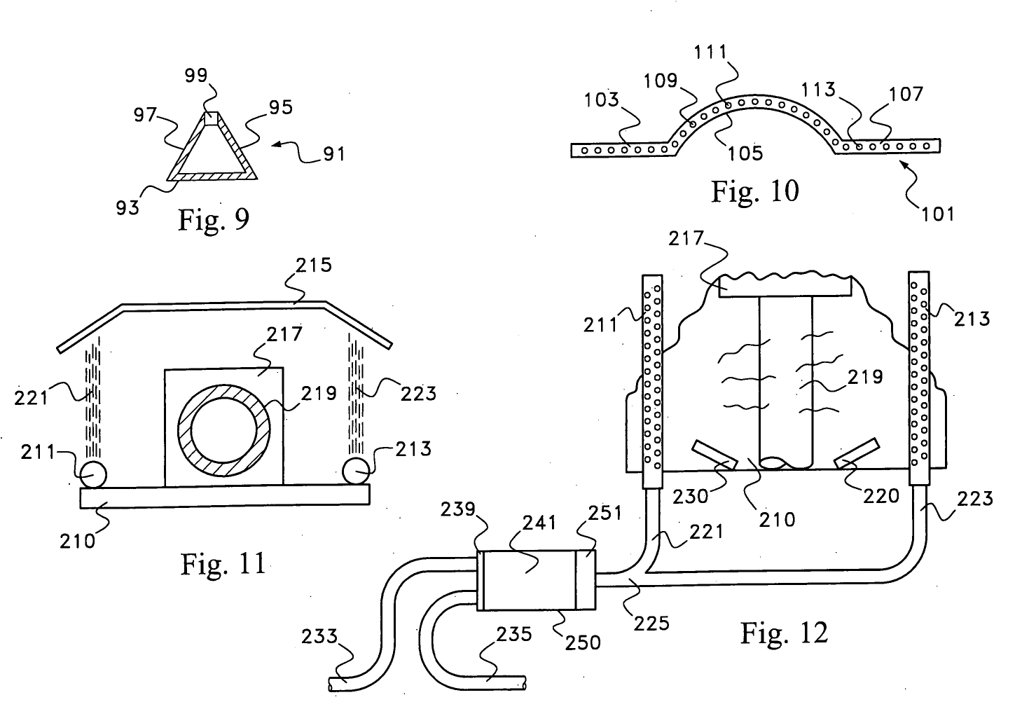

FIGS. 8 and 9 show end views of other cross-sections of two alternative manifold members 81 and 91, respectively. Member 81 has an oval cross-section, with three rows of slits 85, 87, and 89. Member 91 has a trapezoidal cross-section, with a base 93, sides 95 and 97, and a slit top 99.

FIG. 10 shows a top view of a custom shaped manifold member 101 of a present invention device. This shows that any useful shape could be created and will be within the scope of the present invention. Manifold member 101 has a straight section 103, a curved section 105 and another straight section 107, all with orifices to create a similarly shaped curtain of ionized oxygen.

FIG. 11 illustrates an end view of a present invention configuration in an extrusion plant, and FIG. 12 shows a cut top view thereof with the top hood removed. Referring to both Figures, extruder 217 is extruding a composite pipe 219 made of composite plastic, strand and other materials, and emits a smelly and harmful gas at its extruder exit area. This could cause undesirable gases to circulate about the production plant, but a hood 215 is used, with an exhaust fan. This could remove much of the bad gases, but workers near the extrusion may still be overcome or otherwise offended by the gases. Platform 210 has a first manifold member 211 and a second manifold member 213, as shown Fans 230 and 220 are optional but may help to keep th gases confined. Manifold members 211 and 213, respectively emit strong curtains 221 and 223 that contain ionized oxygen to reduce harmful gases. The curtains are forceful and work efficiently, but are essentially invisible, enabling workers to inspect the extrusion process without exposure to the bad gases.

FIGS. 13, 14, 15 and 16 show different examples of manifold arrangements in terms of curtain positioning. FIG. 13 shows a basic manifold member 301, with a tube 303, orifices, such as orifice 305, connector 307, and a curtain 309. Curtain 309 is straight, and generally planar, but could be slightly radiating. Taken as a top view, curtain 309 is a horizontal curtain or blanket that could be above or even below a bad gas source. Taken as a front view, it illustrates a present invention vertical curtain. In other words , the present invention manifolds could be placed horizontally, vertically or at a slant from vertical to create the screen or curtain desired.

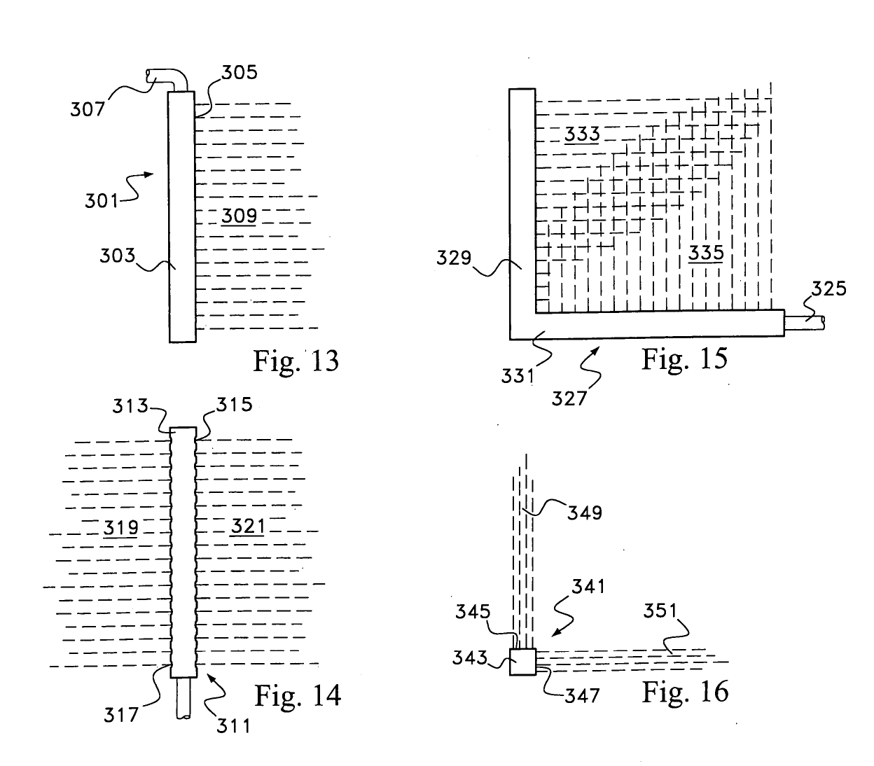

FIG. 14 illustrates a single manifold member 311, with two, one hundred eighty degrees offset, curtain orifice sets 315 and 317 to create curtains 319 and 321 flowing in opposite directions, but in a single plane.

FIG. 15 shows a corner unit intended for use with other straight and corner units to create a curtain cage of ionized oxygen gases. Comer unit manifold member 327 has right angle tubing with a segment 331 and a continuing segment 329 at ninety degrees thereto. It has a connector for attachment to an ionized oxygen source, and creates curtain segments 333 and 335, as shown.

FIG. 16 shows another manifold member 341, with two sets of orifices 345 and 347 at right angles to one another. These create curtains 349 and 351, as shown. It should now be realized that other curtain angles and shapes may be configured within the scope of the present invention.

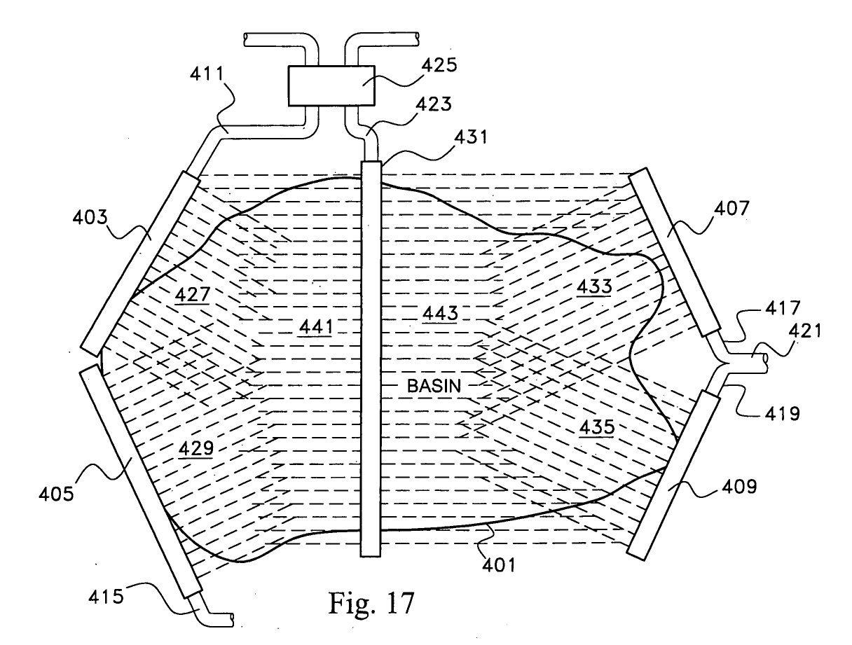

FIG. 17 shows a top view of an open basin using the present invention devices, and illustrates a method of the present invention. The term “basin” as used herein means tank, pond or other manmade or natural holding area for manmade fluid material, such as wastewater, slurry and the like. Open basin 401 contains a fluid that emits undesirable gases, e.g., from a pig farm, or a chemical process. Present invention devices have numerous manifold members 403, 405, 407, 409, and 431 strategically in place to blanket the entire basin with ionized oxygen gas to reduce odors and too curtain the bad gases. Each of these manifold members 403, 405, 407, 409, and 431 are all connected to various sources of ionized oxygen as shown in Figure via connection lines 411, 415, 417, 419, and 423, respectively. Lines 411 and 423 connect to a common main housing 425. Line 417 and 419 connect to a common connecting outtake line 421 that is connected to a different main housing (not shown). Line 415 may be connected to its own main housing or either of the aforementioned. These devices create curtains 427, 429, 433, 435, 441 and 443 to blanket the open basin. Note that manifold member 431 is similar to manifold member 311 shown in FIG. 14 above.

Obviously, numerous modifications and variations of the present invention are possible in light of the above teachings. It is therefore understood that within the scope of the appended claims, the invention may be practiced otherwise than as specifically described herein.

1. An ionized oxygen curtain device for creating a gaseous curtain containing ionized oxygen, which comprises:
(a.) a main housing;
(b.) an ionized oxygen generator located in the main housing;
(c.) a circulation mechanism connected to said main housing;
(d.) a gas intake upstream from said generator and connected to said main housing to permit oxygen-containing gas to enter the main housing;
(e.) an ionized oxygen gas outtake downstream from said generator and connected to said main housing to permit ionized oxygen-containing gas to flow from said main housing; and,
(f.) a manifold member connected to said outtake, said manifold member being elongated, and having an elongated outlet arrangement in a predetermined geometry cross-sectional area so as to permit a curtain-like flow of ionized oxygen-containing gas therefrom.

2. The ionized oxygen curtain device of claim 1 wherein said ionized oxygen generator includes sufficient ionized oxygen generation to produce from about 2,000 to about 50,000 oxygen ions per cubic centimeter.

3. The ionized oxygen curtain device of claim 1 wherein said circulation mechanism includes sufficient flow rate to provide a total gaseous flow rate to produce an exit velocity of at least about ten feet per second.

4. The ionized oxygen curtain device of claim 1 wherein said manifold member is an elongated tubular member having a cross-section selected from the group consisting of circular, square, rectangular, oval and triangular.

5. The ionized oxygen curtain device of claim 1 wherein said manifold member has a plurality of generally aligned orifices along a predetermined length.

6. The ionized oxygen curtain device of claim 1 wherein said manifold member has at least one elongated slit for the outer arrangement.

7. The ionized oxygen curtain device of claim 5 wherein said orifices of said plurality of generally aligned orifices are located in a single plane.

8. The ionized oxygen curtain device of claim 6 wherein said at least one elongate slit is located in a single plane.

9. The ionized oxygen curtain device of claim 5 wherein said orifices of said plurality of generally aligned orifices are located on an arcuate plane having an angle no greater than 40 degrees.

10. The ionized oxygen curtain device of claim 9 wherein said arcuate plane is no greater than 30 degrees.

11. The ionized oxygen curtain device of claim 6 wherein said at least one elongated slit is located on an arcuate plane no greater than 40 degrees.

12. The ionized oxygen curtain device of claim 11 wherein said arcuate plane is no greater than 30 degrees.

13. The ionized oxygen curtain device of claim 1 wherein an internal cross-sectional area of said elongated outlet arrangement of said manifold member is related to maintenance of an exit velocity of at least about ten feet per second.

14. The ionized oxygen curtain device of claim 1 wherein said ionized oxygen gas outtake is connected to a plurality of ionized oxygen gas sub-outtakes, and each of said sub-outtakes is connected to a manifold member.

15. A method of isolating a human work area from exposure to a volatile airborne contaminants source, which compromises:
I. providing an ionized oxygen curtain device between said human work area and said volatile airborne contaminants source, said device including:
(a.) a main housing;
(b.) an ionized oxygen generator located in said main housing;
(c.) a circulation mechanism connected to said main housing;
(d.) a gas intake upstream from said generator and connected to said main housing to permit oxygen-containing gas to enter said main housing;
(e.) an ionized oxygen gas outtake downstream from said generator and connected to said main housing to permit ionized oxygen-containing gas to flow from said main housing; and,
(f.) a manifold member connected to said outtake, said manifold member being elongated, and having an elongated outlet arrangement in a predetermined geometry cross-sectional area so as to permit a curtain-like flow of ionized oxygen-containing gas therefrom;
II. creating ionized oxygen curtain between said device human work area and said volatile airborne contaminants source.

16. The method of claim 15 wherein said ionized oxygen generator includes sufficient ionized oxygen generation to produce from about 2,000 to about 50,000 oxygen ions per cubic centimeter.

17. The method of claim 15 wherein said circulation mechanism includes sufficient flow rate to provide a total gaseous flow rate to produce an exit velocity of at least about ten feet per second.

18. The method of claim 15 wherein said manifold member has a plurality of generally aligned orifices along a predetermined length.

19. The method of claim 15 wherein said manifold member has at least one elongated slit for the outer arrangement.

20. The method of claim 15 wherein an internal cross-sectional area of said elongated outlet arrangement of said manifold member is related to maintenance of an exit velocity of at least about ten feet per second.

21. A method of isolating an area of air above an open basin from exposure to volatile airborne contaminants emitting from said open basin, which compromises:
I. providing an ionized oxygen curtain device between said area of air above said open basin and said volatile airborne contaminants emitting open basin, said device including:
(a.) a main housing;
(b.) an ionized oxygen generator located in said main housing;
(c.) a circulation mechanism connected to said main housing;
(d.) a gas intake upstream from said generator and connected to said main housing to permit oxygen-containing gas to enter said main housing;
(e.) an ionized oxygen gas outtake downstream from said generator and connected to said main housing to permit ionized oxygen-containing gas to flow from said main housing; and,
(f.) a manifold member connected to said outtake, said manifold member being elongated, and having an elongated outlet arrangement in a predetermined geometry cross-sectional area so as to permit a curtain-like flow of ionized oxygen-containing gas therefrom;
II. creating ionized oxygen curtain between said area of air above said open basin and said volatile airborne contaminants emitting open basin.

22. The method of claim 21 wherein said ionized oxygen generator includes sufficient ionized oxygen generation to produce from about 2,000 to about 50,000 oxygen ions per cubic centimeter.

23. The method of claim 21 wherein said circulation mechanism includes sufficient flow rate to provide a total gaseous flow rate to produce an exit velocity of at least about ten feet per second.

24. The method of claim 21 wherein said manifold member has a plurality of generally aligned orifices along a predetermined length.

25. The method of claim 21 wherein said manifold member has at least one elongated slit for the outer arrangement.

26. The method of claim 21 wherein an internal cross-sectional area of said elongated outlet arrangement of said manifold member is related to maintenance of an exit velocity of at least about ten feet per second.
